(19) United States
(12) Patent Application Publication
(10) Pub. No.: US 2015/0340111 A1
(43) Pub. Date: Nov. 26, 2015

(54) DEVICE FOR DETECTING UNAUTHORIZED MANIPULATIONS OF THE SYSTEM STATE OF AN OPEN-LOOP AND CLOSED-LOOP CONTROL UNIT AND A NUCLEAR PLANT HAVING THE DEVICE

(71) Applicant: AREVA GMBH, ERLANGEN (DE)

(72) Inventor: SIEGFRIED HALBIG, BUBENREUTH (DE)

(21) Appl. No.: 14/819,637

(22) Filed: Aug. 6, 2015

Related U.S. Application Data
(63) Continuation of application No. PCT/EP2014/051837, filed on Jan. 30, 2014.

(30) Foreign Application Priority Data
Feb. 6, 2013 (DE) 10 2013 201 937.8

(51) Int. Cl. G21D 3/00; G05B 19/05

(52) U.S. Cl. CPC G21D 3/001; G05B 19/058; G05B 2219/161

(57) ABSTRACT

A device detects unauthorized manipulations of a system state of an open-loop and closed-loop control unit, in particular of a programmable logic controller, of a nuclear plant. The device should be able to reliably detect unauthorized manipulations. For this purpose, a monitoring module is provided, which monitors the operating state, hardware expansion state and/or program state of the open-loop and closed-loop control unit and generates an indication when the state changes.

### CROSS-REFERENCE TO RELATED APPLICATION

This is a continuation application, under 35 U.S.C. §120, of copending international application No. PCT/EP2014/051837, filed Jan. 30, 2014, which designated the United States; this application also claims the priority, under 35 U.S.C. §119, of German patent application No. DE 10 2013 201 937.8, filed Feb. 6, 2013; the prior applications are herewith incorporated by reference in their entirety.

### BACKGROUND OF THE INVENTION

### Field of the Invention

The invention relates to a device and a method for detecting unauthorized manipulations of the system state of a control and regulating unit of a plant, in particular a programmable logic controller of a plant such as a nuclear plant. It furthermore relates to a programmable logic controller, a digital monitoring installation for a nuclear plant and a corresponding nuclear plant.

In plants, such as, for example, plants for energy generation (nuclear power plants) a multiplicity of interworking processes run in parallel which normally contain control and regulating processes. Control and regulating units optimized and configured for the application are used for the respective processes.

Due to the increasing data networking of nuclear plants also, in particular energy-generating plants also, and their connection to external networks through to the Internet, these plants are prone to attacks from viruses or other harmful software. A known case in which a plant of this type was attacked with a software virus was STUXNET. An attack of this type can result in production losses through to the total outage of plants and can cause serious personal injury and economic damage. A harmful software introduced in this way can furthermore be used for industrial espionage. In addition, in the case of a first-time attack by a virus, the risk of spreading of the virus exists, so that the virus can attack further control devices of the same nuclear plants or control devices of plants networked with it. Due to this risk, the use of control systems whose memory configuration can in principle be modified in runtime by harmful software can represent a high security risk in networked environments. Control systems of this type are programmable logic controllers (PLC).

### SUMMARY OF THE INVENTION

The object of the invention is therefore to provide a device with which unauthorized manipulations can be reliably detected. Furthermore, a programmable logic controller and a digital monitoring installation for a plant, a nuclear plant and a corresponding method are intended to be provided.

With regard to the device, the object is achieved according to the invention in that a monitoring module is provided which monitors the operating state and/or the hardware configuration state and/or the program state of the control and regulating unit and generates a message in the event of changes in this state.

Advantageous designs of the invention form the subject-matter of the subclaims.

The invention is based on the notion that attacks by viruses or similar harmful software are successful if they can influence the system state of control and/or regulating systems in such a way that their functionality is changed, extended or destroyed in an unwanted manner. This can occur if a harmful program and/or harmful data are loaded into a memory that is writable during operation and are executed. For this reason, it initially appears problematic to use control and/or regulating systems of this type in security-critical plants. In nuclear plants, compliance with the highest security standards is required, since changes in the control systems can result in espionage, outage of components, malfunctions and serious accidents.

In the case of an attack of this type, an attempt would be made, for example, to load additional program code into the control and regulating unit or to replace existing program code with infected code. Furthermore, an attempt could be made to modify a configuration in such a way that data can no longer be received from sensors and/or actuators can no longer be operated or controlled.

As has now been recognized, the required high security standards can be implemented by monitoring the system-internal processes of a control and regulating unit used in a plant of this type, in other words therefore the operating state and/or the hardware configuration state and/or the program state of the control and regulating unit, and by signaling changes.

Through the generation of a message, an investigation can be carried out immediately to identify the type of change and, where relevant, determine whether it was made without authorization. A direct response to this change is furthermore enabled. In the context of the application, a control and regulating unit means any electronic unit that can carry out only control processes or only regulating processes, or both types of processes.

The control and regulating unit preferably has at least one writable memory with data stored therein, wherein the monitoring module generates a message in the event of changes in the data stored in the memory. The operating state, the hardware configuration state and the program state of a control and regulating unit with a writable memory such as a programmable logic controller are essentially determined by its memory content. The memory content normally contains the program code, the hardware and software configuration and dynamically created data fields, variables, etc. A hostile attack from outside by harmful software will manifest itself in changes in the memory, so that changes in the memory content can indicate unauthorized manipulations.

The data advantageously contains the program code or program variables generated therefrom. The program code, in particular a loadable application program, is executed in runtime during operation and contains the instructions that are carried out. Changes in the program code indicate manipulations. However, in order to detect such manipulations, the code does not necessarily have to be monitored directly for changes. It is more effective and economical if program variables derived therefrom or generated by the program code (application code, firmware, operating system, etc.), i.e. to a certain extent secondary program variables, are monitored for changes, insofar as, if changes are made to the code, changes will also occur with sufficiently high probability in these variables. This is, for example, the case with checksums or lengths generated from the code or code segments or code components. The CPU advantageously has the “exclusive-or operation via the checksums of the software components or modules” as an internal functionality. The results (for example 32-bit values) are then read out by the monitoring module and are monitored for changes. Programmable logic controllers such as the SIMATIC S7-300 and the SIMATIC S7-400 automatically generate checksums, in particular transverse sums. These only need to be read out by the monitoring module and monitored for changes. Any program change can thus be detected by an old/new value comparison.

The data advantageously comprise the system data, in particular the hardware configuration, and/or system variables generated therefrom. In modular systems, the hardware configuration contains data for the modules that are used. The hardware configuration is planned, for example in the SIMATIC, via the HWConfig contained in the STEP7/PCS7 programming software. Each module that is to be plugged into a modular S7-300 or S7-400 must be parameterized in the HWConfig in order to be executable and must then be loaded onto the CPU of the target station. All settings such as the module address, diagnostic settings, measurement range settings, etc., of the respective module are parameterized in the HWConfig. As a result, settings via e.g. bridge circuits, etc., can be omitted. In the case of a module exchange, no further settings are required.

The aforementioned planning is stored in the system data. A check for changes in these system data allows the detection of possible attacks. As described above, exclusive-or operations via the checksums of the control and regulating unit are also provided, are read out by the monitoring module and monitored for change by means of old/new value comparison.

In one preferred embodiment, the monitoring module monitors the setting of an operating mode switch of the CPU of the control and regulating unit. An operating mode switch of this type can have a plurality of settings. These may, for example, be:

MRES (reset of the variable memory)

STOP (no program processing, only communication possible)

RUN (program processing with blocked program change facility)

RUN-P (program processing with program change facility).

In the case of many current CPUs without a key switch, only the “START” and “STOP” switch settings exist, wherein no program processing is possible in the “STOP” setting, so that in this case a program evaluation in the CPU brings about no change.

It can furthermore be provided that the monitoring module monitors changes in a security level of the control and regulating unit. The security level may, for example, have the “read-only” or “read and write” settings, in each case combined with password protection.

If changes in the operating state, the hardware configuration state or the program are identified during the monitoring, a message is generated, which can be done in different ways. So that the message is available for evaluations at later times, it is advantageously written to a memory, in particular a diagnostic buffer of the CPU of the control and regulating unit and/or a monitoring buffer of the monitoring module. A diagnostic buffer may be configured, for example, as a memory area integrated into a CPU which can accommodate diagnostic entries as a ring buffer. These entries are preferably provided with a date/time stamp. The monitoring module preferably has a monitoring memory to which the message can be written, preferably with a stamp for the date and time. This monitoring memory may be configured, for example, as a ring buffer. An entry of the message can be written to only one of the two memories or, in order to create redundancy, to both memories, if provided.

Alternatively or preferably in addition thereto, the message is provided at an, in particular binary, output of the device, in particular of the monitoring module. As a result, it is available to the project planner for a plant-specific message output. A plurality of outputs are preferably provided which are allocated to the individual types of the detected change (program memory, system data memory, security level, etc.).

A security module is preferably provided which switches over a security level of the control and regulating unit as required, in particular when a key switch is actuated. The security level has, in particular, the “read and write” and “read only” and “write and read protection” settings, wherein these settings may alternatively be linked to a password legitimization. A key switch via which this switchover can be affected, is then, for example, built into the switch cabinet. It can thus be ensured that program changes are made by authorized persons only. Without the switchover or actuation of the key switch, program changes are to a certain extent locked and therefore excluded. The key switch is wired to any given digital input. In the control program, this signal is switched to a module (SecLev_{—}2) which then sets the security level via a system function.

In one preferred embodiment of the device, a control module is provided which monitors the operation of the monitoring module, wherein the monitoring module also monitors the operation of the control module. The notion underlying this design is as follows: For an attacker to be able to make an undetected program change in the control and regulating unit, he must first obtain write access by setting the security level to “read and write”. In addition to this, he must prevent the activity of the monitoring module, i.e., in the case of an implementation of the monitoring module by a software module or by a software package, he must prevent its processing or the processing of its program instructions by the CPU. The control module is provided in order to detect or intercept the processing.

The monitoring module and the control module monitor each other's operation. This does not therefore entail a simple redundant monitoring of the control and regulating unit. In the preferred case wherein the monitoring module and the control module are implemented as software packages, both modules monitor each other's processing instead. This is advantageously done by checking whether a correct processing of the respectively monitored module takes place during a predefined time span, e.g. one second. If not, the absence of processing is reported, which may indicate an attempted or already accomplished compromise.

An erasure of software packages from outside through an attack is possible only in succession. This means that the attacker, insofar as he can acquire any knowledge at all of the existence of both modules and their functionalities, must erase or deactivate the modules in succession. If one of the two modules is erased or deactivated, this is, however, detected by the respective other module and a corresponding message is generated so that the outage of one of the two modules is reliably detected.

In the case where the control module detects irregularities in the operation of the monitoring module, it indicates the defective operation or defective processing of the monitoring module advantageously on a binary output. The monitoring module indicates irregularities in the operation of the control module in at least one of the ways described above; a message is written to a memory or buffer of the CPU or the monitoring module, preferably together with a date/time stamp, and is made available on a (binary) output for the further plant-specific message output. All three ways are preferably used.

With regard to the programmable logic controller, the aforementioned object is achieved according to the invention with a device described above which is integrated by software modules. This means that the aforementioned modules (monitoring module, control module, security module) are implemented in each case as software modules or software packages and, when the control and regulating unit is in operation, are located in the memory of the unit.

With regard to the digital monitoring installation for a nuclear plant, the aforementioned object is achieved according to the invention with a programmable logic controller described above.

With regard to the nuclear plant, the aforementioned object is achieved according to the invention with a digital monitoring installation of this type.

With regard to the method, the aforementioned object is achieved in that the operating state and/or the hardware configuration state and/or the program state of the control and regulating unit are monitored and a message is output in the event of changes in this state. Advantageous designs of the method are indicated by the functionalities described in connection with the device.

The invention offers the particular advantages that an undiscovered manipulation is largely prevented and is reliably reported through the monitoring of the operating state, the hardware configuration state and the program state of the control and regulating unit, so that measures can be instigated immediately and in a targeted manner to avoid damage to the plant. Programmable logic controllers can be used in this way in networked, security-critical environments only. Manipulations cannot be carried out by deactivating the monitoring due to the reciprocal monitoring of the monitoring module and control module.

Other features which are considered as characteristic for the invention are set forth in the appended claims.

Although the invention is illustrated and described herein as embodied in a device for detecting unauthorized manipulations of the system state of an open-loop and closed-loop control unit and a nuclear plant having such a device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a nuclear plant with a digital monitoring unit with a control and regulating unit with an integrated device with a monitoring module, security module and control module in according to the invention;

FIG. 2 is a flow chart showing the functionality of the security module of the device according to FIG. 1;

FIG. 3 is a flow chart showing the functionality of the monitoring module of the device according to FIG. 1; and

FIG. 4 is a flow chart showing the functionality of the control module of the device according to FIG. 1.

### DETAILED DESCRIPTION OF THE INVENTION

The same parts are denoted in all figures with the same reference numbers.

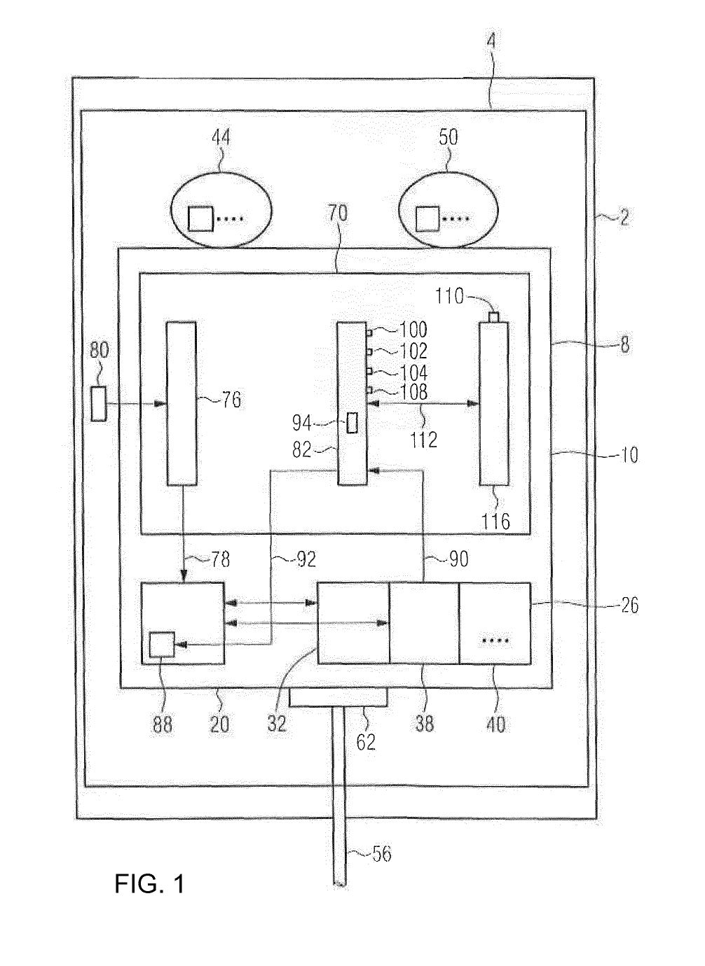

Referring now to the figures of the drawings in detail and first, particularly to FIG. 1 thereof, there is shown a nuclear plant 2 which has a digital monitoring installation 4 with a control and regulating unit 8 which is configured as a modular programmable logic controller (PLC) 10. This may involve, for example, a SIMATIC S7-300 or S7-400 from Siemens. This includes a CPU 20 and a memory 26 which includes a plurality of memory areas. The program(s) which is/are executed during the operation of the PLC 10 is/are stored in a program memory area 32. In addition to this, checksums of the code and its lengths are stored which are calculated by the CPU 20 during the transfer of the programs onto the CPU and are updated immediately in the event of changes. Similarly, exclusive-or operations are calculated via these checksums, are stored in the system data memory 38 and are updated in the event of changes. It can also be provided that these variables derived from the program code are stored in a dedicated memory area.

Configuration data, in particular the configuration data of the hardware, are furthermore stored by the CPU 20 in the system data memory area 38. For a module to be executable in a modular-design PLC 10 as in the present case, the module must be parameterized in the hardware configuration and must then be uploaded onto the CPU 20. All settings such as the module address, diagnostic settings, measurement range settings, inter alia, of the respective module are parameterized in the hardware configuration. In the case of a module exchange, no further settings are then required. The memory 26 additionally contains further memory areas 40.

The PLC 10 is connected on the input side to sensor groups 44 which comprise a number of sensors and on the output side to actuator modules 50 which for their part comprise a number of actuators. A data line 56 leads from outside into the nuclear plant and connects the PLC 10 via an interface 62 to a Local Area Network (LAN) or to the Internet. This connection offers the possibility for potential attackers to attempt to introduce a virus into the CPU 20 or install other types of harmful software in order to either obtain information on the data stored in the CPU 20 (industrial espionage) or to modify, prevent or destroy the functionality of the PLC 10. A successful attack of this type can result in serious personal injury and also economic damage if the PLC 10 is responsible for controlling security-critical processes.

In order to prevent this injury and damage and be able to detect attacks and therefore unauthorized manipulations of the operating state, the hardware configuration state and the program state of the PLC 10 reliably and quickly, a device 70 is provided according to the invention which is integrated in the present case into the PLC 10. The device 70 contains three modules 76, 82, 116 which are described below. These modules are implemented as software packages and are stored in the program memory area.

A security module 76, represented by an arrow 78, has access to the security level of the CPU 20. For this purpose, it is configured to switch over the security level between “read and write”, “read-only” and “read and write protection” or vice versa. This functionality is linked to a key switch 80 which is built into a switch cabinet (not shown). This means that, in a first setting of the key switch, the security module 76 activates the “read and write” security level and, in a second setting of the key switch, the security module 76 activates the “read only” or alternatively the “read and write protection” security level. In ongoing operation, the second setting is the default setting, so that no program changes or other changes can be made in the memory 26 by unauthorized persons. Changes are possible only when the key switch is in the first position. The attacker would therefore either have to obtain access to the key switch, i.e. gain access to the plant, which can largely be prevented by conventional security measures. When the key switch is in the first position, he could possibly also erase by introducing harmful software or directly change the security level in the CPU via the programming.

A monitoring module 82 is provided in order to reliably detect the introduction of harmful software in any form or unauthorized changes in the operating state, the hardware configuration state and the program state of the PLC 10. As indicated by an arrow 90, the monitoring module 82 monitors changes in the program memory area of the memory 32. This is done in the following manner: The CPU 20 generates checksums and program lengths for each package from the program code stored in the program memory area 32. Through exclusive-or operations via these individual checksums and program lengths, a total checksum (32-bit number) is formed and stored in the system data memory 38. The results (total checksum) of these operations are monitored for changes. To do this, an old/new value comparison is carried out at predefined time intervals.

As represented by an arrow 90, the monitoring module 82 also monitors the system data memory area 38 for changes. This is again done via the checking of changes in the exclusive-or operations generated and provided by the CPU 20 via the lengths and checksums of the system data. The monitoring module 82 furthermore monitors changes in the security level of the CPU 20 which is similarly stored in the system data memory.

In the event of changes in the monitored results, the monitoring module 82 generates messages in three different ways. On the one hand, the messages are written to the diagnostic memory 88 of the PLC 10. The latter is a memory area designed as a ring buffer which is integrated into the CPU 20 and can accommodate up to 500 diagnostic entries. Even after a “total erasure” (total erasure is a function in which the complete memory of the CPU is erased except for the diagnostic buffer 88, i.e. a totally erased CPU does not function (or no longer functions)) or simultaneous battery and mains failure, this memory is still readable. It is thus ensured through the writing of the message to the diagnostic memory 88 that the message is not lost, even after power failures. The content of the diagnostic buffer can, on the one hand, be read out via the STEP7/PCS7 programming software and displayed. On the other hand, specific HMI devices/software systems such as e.g. WinCC or PCS7 OS can similarly display these diagnostic buffer entries in clear text with a date/time stamp.

The monitoring module 82 also writes a message to a monitoring buffer 94 configured as a ring buffer which is implemented in the monitoring module 82 and, in the present case, can accommodate 50 entries. Each entry consists of a date/time stamp and one bit per occurring change. The monitoring buffer 94 can be read out and evaluated by means of STEP7/PCS7.

The message is furthermore provided or displayed in each case on a binary output 100, 102, 104 on the monitoring module and is thus made available for further processing. Following alarm signaling, the operator can, if required, read out more detailed information via the diagnostic buffer or monitoring buffer. A dedicated binary output 100, 102, 104 is allocated in each case to each of the three monitoring options described above (program code, system data, security level) so that the setting of a bit suffices to produce a message. Messages in the event of changes in the program code are produced at the binary output 100, messages in the event of changes in the system data are produced at the binary input 102 and messages in the event of changes in the security level are produced at the binary input 104, in each case by the setting of a bit.

Attempts to make changes to the system data and/or the program code which may, for example, be the effects of a virus attack with which the functionality of the PLC 10 is intended to be impaired can be detected by the described monitoring module 82 on the basis of the generated messages. However, the generation of the messages could be prevented insofar as the attacker partially or completely erases or deactivates the monitoring module 82 before the monitoring module 82 notices the intrusion and can generate a message. A control module 116 is provided in order to prevent scenarios of this type. As represented by a double arrow 112, the monitoring module 82 and the control module 116 monitor each other. This is done in the present case in such a way that the processing of the program instructions is in each case monitored. To do this, a check is carried out in each case to determine whether the processing of the instructions of the program code has been continued at a predefined time interval, here 1 second (control programs normally run in time slices of 10 to 100 milliseconds). If one of the two modules 82, 106 detects that the processing is not continued in the respective other module 82, 106, it generates a corresponding message so that a response can be made to a possible attack.

The control module 116 indicates the defective or absent processing of the monitoring module 82 on a binary output 110. As described above in connection with the monitoring processes of the memory 26, the defective or absent processing of the monitoring module 82 is written in each case with a date/time stamp to the diagnostic buffer 88 and the monitoring buffer 94 and is made available at the binary output 110 for further plant-specific message output.

This mechanism is extremely reliable, since an attacker would initially have to acquire knowledge from outside of the very existence of two modules 82, 116 which control and monitor each other. Furthermore, it will not be possible for him to erase both modules 82 and 116 simultaneously, so that at least one of the two modules 82 or 116 generates a message and the attack becomes detectable as a result. However, the failure or malfunctions of one of the two modules 82, 116 can be detected even without an attack.

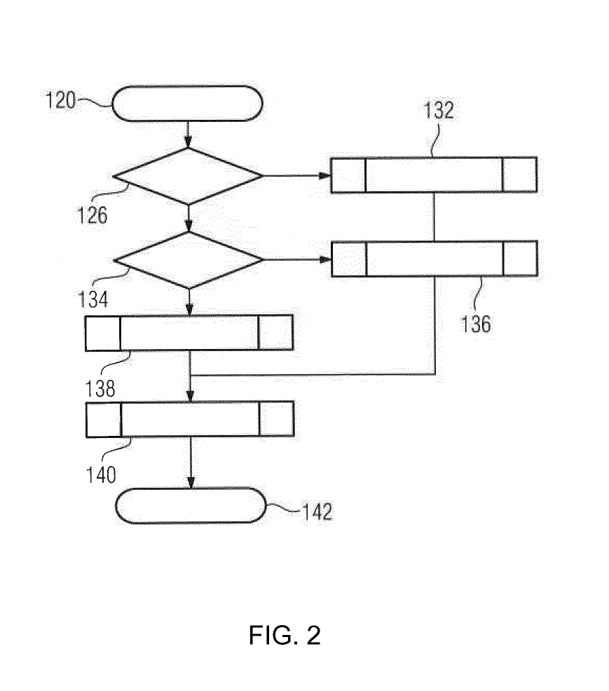

A flow diagram of the method steps which take place during the operation of the security model 76 is shown in FIG. 2. The method implemented through software in the security module 76 begins at the start 120. In a decision 126, a check is carried out to determine whether the key switch 80 produces a valid signal which enables read/write access, and whether the status of this signal is simultaneously valid or a simulation is taking place. If all these conditions are satisfied, the method branches to block 132 in which the security level of the CPU 20 is switched to read/write access, corresponding to a security level 1.

If not, the method branches to a decision 134 in which a check is carried out to determine whether read and write access is to be prevented without password legitimization. If so, the method branches to block 136 in which the security level of the CPU 20 is switched to read/write access without password legitimization. In block 138, if the above two decisions 126, 134 turned out to be negative, the security level is switched to write protection with password legitimization, corresponding to a security level 2. In block 140, the current security level is read out and displayed. The method ends at the end 142.

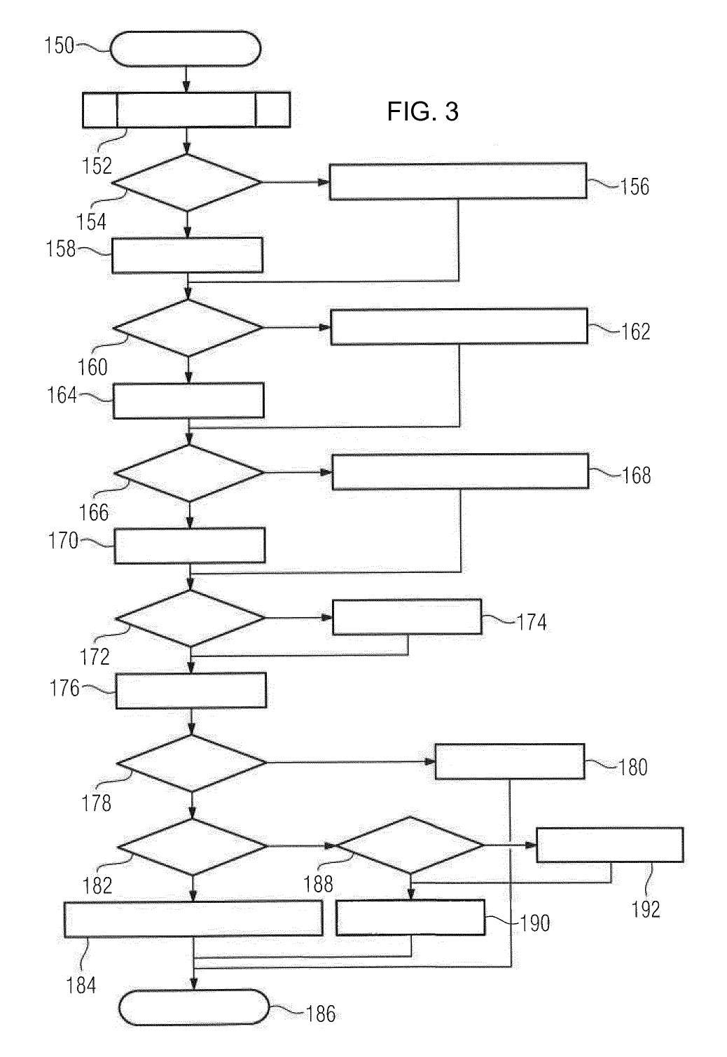

A method implemented through software in the monitoring module 82 is shown by means of a flow diagram in FIG. 3 and begins at the start 150. In block 152, the checksums, here transverse sums, for the hardware configuration HWConfig, the program code and the security level are read out. In the decision 154, a check is carried out by means of an old value/new value comparison to determine whether the value of the checksum of the HWConfig matches the value from the last query. If not, the method branches to block 145. A “HWConfig change” message entry is recorded or written there in the monitoring buffer 94 and in the diagnostic buffer 88, in each case with a date/time stamp, and the binary output 102 is set for the plant-specific further processing, i.e. the bit is set to the value corresponding to a message (e.g. 1 for message, 0 for no message). If no change in the transverse sum is identified through the old value/new value comparison, the output 102 is reset in block 158, thereby ensuring that a message is not erroneously displayed.

In a decision 160, a check is carried out to determine whether the value of the read out transverse sum of the program code has changed compared with its previous value from the last query. If so, the method branches to block 162. A “program change” message entry is written there to the monitoring buffer 94 and the diagnostic buffer 88, including a date/time stamp, and the output 100 is set. If not, the output 100 is reset in block 164.

In a decision 166, a check is carried out to determine whether the security level of the CPU 20 has changed since the last query. If so, in block 168, a “change of security level” message entry is written together with a time stamp to the monitoring buffer 94 and the diagnostic buffer 88. The output 104 is furthermore set. If not, this output is reset in block 170.

In a decision 172, a test is carried out to determine whether the call of the described method steps is older than 1 second. If so, a parameterization error is output in block (the three described modules 76, 82, 116 are made available with further modules in the library for an application. The user can select/set different behaviors by parameterizing the modules during the programming or commissioning. If the user parameterizes/selects an impermissible behavior, he receives a parameterization error display and can correct his parameterization). If not, the method branches to block 176 in which the parameterization error is reset.

The reciprocal monitoring of the monitoring module 82 and the control module 116 is achieved in the present example embodiment in that each module in each case has a counter which it increments itself, and also a counter which is incremented by the respective other module. If both modules 82 and 116 are functioning correctly, the counters in each case have the same values. If one module fails, the counter in the other module incremented by it is no longer increased, so that the failure of the module can be detected.

The method now continues to a decision 178 in which the value of a monitoring counter incremented by the monitoring module 82 is compared with the value of a control counter incremented by the control module 116. If these values match one another, the monitoring counter is increased in block 180. If the two values do not match one another, a test is carried out in a decision 182 to determine whether the last counter increase of the control counter is older than 1s and no entry has yet been made in the monitoring buffer 94 and the diagnostic buffer 88. If so, this shows that the control module 106 is not working properly. Therefore, in block 184, an “erasure monitoring error” or “control module error” message entry is then recorded in the monitoring buffer 94 and the diagnostic buffer 88, in each case with a time stamp, and a bit is set on a binary output 108 on which errors of the control module 116 are displayed. The method then ends at the end 186. If not, a check is carried out in a decision 188 to determine whether the “monitoring module working again” entry which was recorded in block 184, is already present in the diagnostic offer 88 of the CPU. If so, the output 108 is reset in block 190. If not, in block 192, a “control module working ok” or “erasure monitoring ok” message entry is made in the monitoring buffer 94 and the diagnostic buffer with a timestamp.

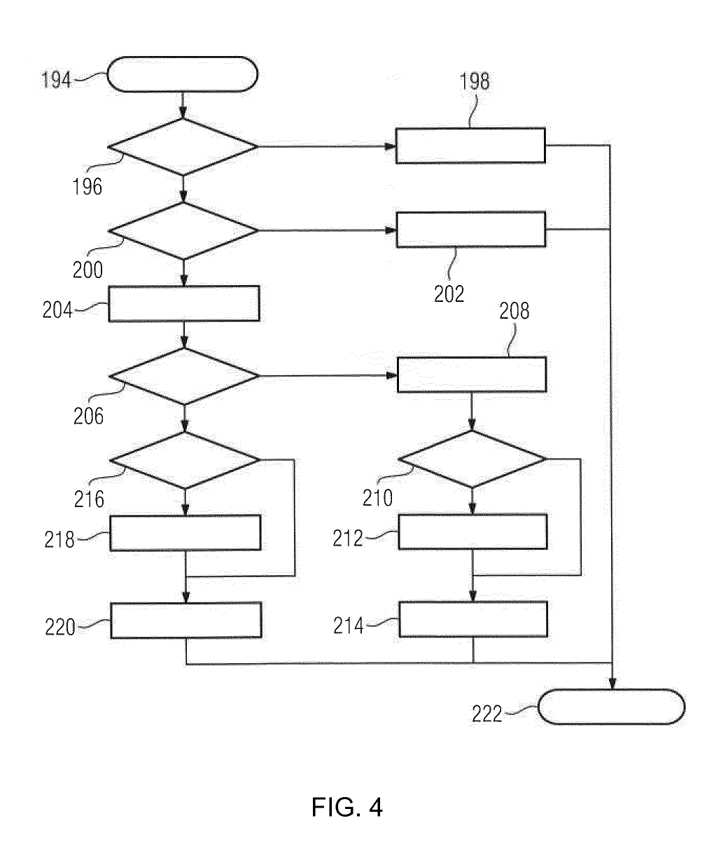

A method implemented through software in the control module 116 is shown as a flow diagram in FIG. 4 and begins at the start 194. In a decision 196, a check is carried out to determine whether the connection to the monitoring module 82 is in order and correct. In the present example embodiment, the user must set up a connection/line in a CFC (Continuous Function Chart) editor between the two modules during the planning/programming by clicking with the mouse. The control module 116 can read and write to the instance data component of the monitoring module 82 by means of this connection. The control module itself does not have its own data memory. If not, a parameterization error is output in a block 198. If so, a check is carried out in a decision 200 to determine whether the last call of this function is older than 1s. If not, a parameterization error is output in block 202. If so, the method continues to block 204 in which the parameterization error is reset.

In the control module 116, if the counter which the monitoring module 82 increments is greater than the counter of the control module 116, the control counter is incremented. The monitoring counter and the control counter are compared with one another in a decision 206. If the monitoring counter is greater than the control counter, the control counter is increased in block 208. In a decision 210, a check is then carried out to determine whether a “monitoring module working again” entry is recorded in the diagnostic buffer 88. If not, this is carried out retrospectively in block 212. The corresponding binary output is then reset in block 214.

If a match is found, a check is carried out in a decision 216 to determine whether the last counter increase of the monitoring counter is older than 1s and no entry has yet been made in the diagnostic buffer 88. If no entry has yet been made, a “monitoring module no longer working” entry is made in the diagnostic buffer 88 in block 218. The output 110 is then reset in block 220.

If the last counter increase was older than 1s and no entry was present, the method branches from the decision 216 directly to block 220. The method is ended at the end 222.

In all three modules the sequence of method steps can also run in a different sequence or in parallel, insofar as the described functionality is retained. The sequence of the method steps shown respectively between the start and end is repeated at regular intervals. The respective module increments its counter updated by it in each case between the start and end by one.

The following is a summary list of reference numerals and the corresponding structure used in the above description of the invention:
2 Nuclear plant
4 Digital monitoring installation
8 Control and regulating unit
10 Programmable logic controller
20 CPU
26 Memory
32 Program memory area
38 System data memory area
40 Further memory areas
44 Sensor modules
50 Actuator modules
56 Data line
62 Interface
70 Device
76 Security module
78 Arrow
80 Key switch
82 Monitoring module
84 Arrow
88 Diagnostic buffer
90 Arrow
92 Arrow
94 Monitoring diagnostic buffer
100 Binary output
102 Binary output
104 Binary output
108 Binary output
110 Binary output
112 Double arrow
116 Control module
120 Start
126 Decision
132 Block
134 Decision
136 Block
138 Block
140 Block
142 End
150 Start
152 Block
154 Decision
156 Block
158 Block
160 Decision
162 Decision
164 Block
166 Decision
168 Block
170 Block
172 Decision
174 Block
176 Block
178 Decision
180 Block
182 Decision
184 Block
186 End
188 Decision
190 Block
192 Block
194 Start
196 Decision
198 Block
200 Decision
202 Block
204 Block
206 Decision
208 Block
210 Decision
212 Block
214 Block
216 Decision
218 Block
220 Block
222 End

1. A device for detecting unauthorized tampering of a system state of an open and closed-loop control unit, the device comprising:
a monitoring module monitoring at least one state selected from the group consisting of an operating state, a hardware expansion state and a program state of the open and closed-loop control unit, said monitoring module generating a message in an event of changes to the state;
a supervision module monitoring an operation of said monitoring module;
said monitoring module monitoring an operation of said supervision module; and
the open and closed-loop control unit containing a programmable logic controller, said monitoring module and said supervision module are software components of the programmable logic controller that both check whether the other module is processing program statements as planned within a predetermined time period.

2. The device according to claim 1, wherein the open and closed-loop control unit contains at least one writable memory containing stored data, and wherein said monitoring module generates the message in an event of changes to the data stored in the writable memory.

3. The device according to claim 2, wherein the data includes at least one of program code or program variables generated therefrom.

4. The device according to claim 2, wherein the data includes at least one of system data, hardware configuration data, or system variables generated therefrom.

5. The device according to claim 1, wherein said monitoring module monitors a position of an operating mode switch of a CPU of the open and closed-loop control unit.

6. The device according to claim 1, wherein said monitoring module monitors changes to a security level of the open and closed-loop control unit.

7. The device according to claim 5, wherein the message is written to at least one of a memory of the CPU of the open and closed-loop control unit or a buffer of said monitoring module.

8. The device according to claim 1, further comprising an output and the message is provided at said output.

9. The device according to claim 1, further comprising a security module for switching a security level of the open and closed-loop control unit as required, and upon actuation of a key-operated switch.

10. The device according to claim 7, wherein the memory of the CPU of the open and closed-loop control unit is a diagnostic buffer.

11. The device according to claim 8, wherein said output is an output of said monitoring module.

12. The device according to claim 1, wherein the open and closed-loop control unit is a component of a nuclear plant.

13. A nuclear plant, comprising:
a device according to claim 1.
